(19) United States
(12) Patent Application Publication
(10) Pub. No.: US 2017/0095939 A1
(43) Pub. Date: Apr. 6, 2017

(54) Tofu cutting device

(71) Applicant: Chikara R. Tateno, Santa Cruz, CA (US)

(72) Inventor: Chikara R. Tateno, Santa Cruz, CA (US)

(21) Appl. No.: 14/756,702

(22) Filed: Oct. 1, 2015

(51) Int. Cl. B26B 29/06; B26B 3/04; B25G 1/10; B26B 27/00

(52) U.S. Cl. CPC B26B 29/063; B26B 27/002; B26B 3/04; B25G 1/102

(57) ABSTRACT

A tofu cutting device for cutting packaged or unpackaged tofu comprises a handle, a frame element secured to the handle, and one or more cutting elements for cutting the tofu. The cutting elements are positioned and secured on the frame element and may be wire(s), blade(s), or various configurations of wire or blade to prepare a chosen tofu cut. The frame element has a base and a first support arm and a second support arm for holding and supporting the one or more cutting elements.

### BACKGROUND OF THE INVENTION

Technical Field

This invention relates to devices for cutting tofu, and more particularly to a hand held tofu cutting device for cutting tofu in containers or otherwise.

Background Art

Tofu, also known as bean curd, is a food made by coagulating soy milk and pressing the curds into soft white blocks. It is a popular component in Asian cuisines. There are many different varieties of tofu and tofu that has been pressed and formed in some manner. Tofu is bought or made to be soft, firm, or extra firm and is a versatile foodstuff that can be used in savory or sweet dishes. It is often seasoned or marinated to suit the particular dish.

Various devices have been proposed and implemented for slicing and cutting tofu and other food products. Although prior devices have been adapted and used for various purposes in connection with cutting and preparing tofu, applicant is not aware of any such hand held tofu devices which can easily and conveniently cut tofu while in the standardized tofu container, typically a two inch tall, three by four inch container. Of course the present invention may be used of to cut and prepare tofu which is otherwise packaged or outside of a container or bag or the like.

The present invention provides a hand held tofu cutting device, which is easy to use and operate, and is highly efficient. The device of the present invention has a handle, and a frame element, and either one a plurality of cutting wires or blades secured and positioned on the frame element. Various configurations of cutting wire or blades may be provided allowing for different cuts and shapes of tofu to be easily produced. The present tofu cutting device is particularly useful for cutting tofu in conventional tofu containers, but may be used on all forms of tofu.

Accordingly, the primary object of the present invention is to provide a tofu device, which is easy to use, highly efficient, and reduces tofu preparation time greatly. The tofu cutting device of the present invention is particularly useful in producing a clean and elegant tofu cut, suitable for restaurants or private food preparation.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out in the appended claims.

### SUMMARY OF INVENTION

To achieve the foregoing objects, and in accordance with the purpose of the invention as embodied and broadly described herein, a tofu cutting device for cutting packaged or unpackaged tofu is provided comprising a handle, a frame element secured to the handle, and one or more cutting elements for cutting the tofu. The cutting elements are positioned and secured on a frame element and may be wire, blades, or various configurations of wire or blade to prepare a chosen tofu cut. The frame element has a base and a first support arm and a second support arm for holding and supporting the one or more cutting elements.

### BRIEF DESCRIPTION OF DRAWINGS

The accompanying drawings, which are incorporated in and constitute a part of the specification, illustrate a preferred embodiment of the invention and, together with a general description given above and the detailed description of the preferred embodiment given below, serve to explain the principles of the invention.

FIG. 1 shows the tofu cutting device for cutting tofu, with two cutting elements according to a preferred embodiment of the invention.

FIG. 2 shows the tofu cutting device, in this embodiment, with one cutting element, according to the invention.

FIG. 3 shows a square configuration of a cutting element, for cutting tofu squares, according to the invention.

FIG. 4 shows triangular configuration of a cutting element, for cutting triangular tofu pieces, according to the invention.

FIG. 5 shows spindly or julienne type cutting element configuration, according to the invention.

FIG. 6, shows a layer type cutting configuration of the cutting elements, according to the invention.

FIG. 7, shows a tofu block in a standard tofu container being cut by the tofu cutting device, according to the invention.

### DETAILED DESCRIPTION OF THE PREFERRED EMBODIMENT

Reference will now be made in detail to the present preferred embodiments of the invention as illustrated in the accompanying drawings.

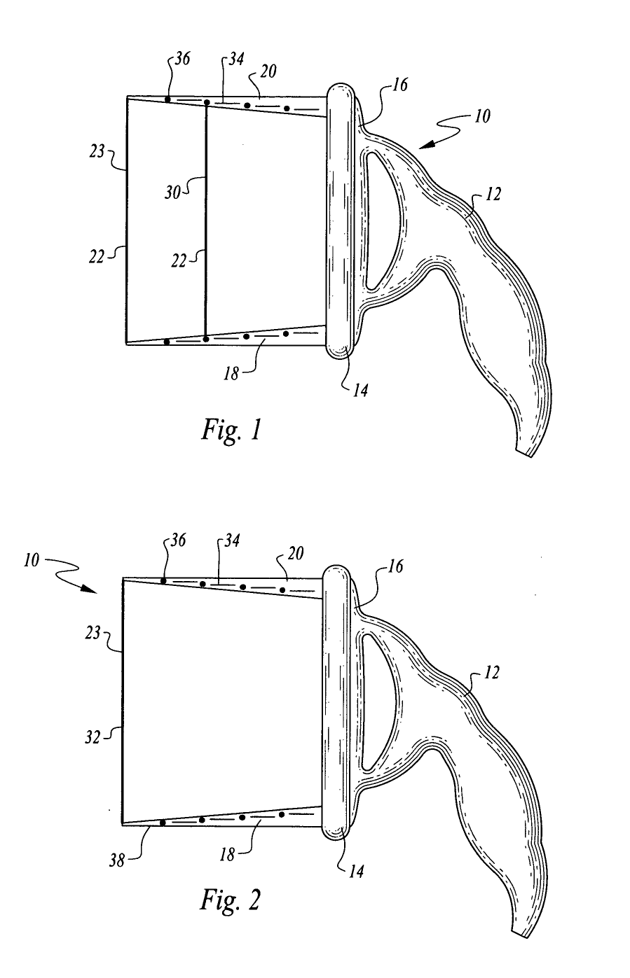

In accordance with the present invention, as seen in FIG. 1, tofu cutting device 10, is shown with handle 12, a frame element 14, secured to handle 12, one or more cutting elements 22, shown in FIG. 1 with two cutting elements 23 and 30, here wires, for cutting and slicing tofu. Handle 12, may be composed of metal, plastic, wood, composite or a combination of such, to provide a firm and durable gripping surface. Frame element 14, is preferably configured with base 16, and a first support arm 18, and a second support arm 20, to which cutting elements 22, can be secured by mechanical fasteners, such as clamps, rings screws or the like, or by a groove or slot, or adhesives, or formed integrally with first arm 18, and second arm 20, in manufacture which is the preferred manner of attachment. Preferably the one or more cutting elements 22, are secured under tension proving a taught, firm cutting surface(s). First arm 18, and second arm 20, of frame element 14, are preferably composed of stainless steel, but other metals, or other durable resilient materials such as plastic, composites, wood, or the like may be used.

Cutting elements 22, are operably positioned and secured on frame element 14, and may be provided in a wide variety of configurations and combinations, as seen in FIGS. 1-7. Cutting elements may be provide as wires 23 and 30, as seen in FIG. 1, or as a cutting blade 32, as seen in FIG. 2, or in other embodiments as a combination of a wire and a cutting blade. The wire(s) and blade(s) may be composed of metal, plastic, or other durable resilient material.

As seen in FIGS. 1 and 2, tofu cutting device 10, is preferably configured with base 16, first support arm 18, and second support arm 20, for positioning and securing cutting elements 22. In FIG. 1, cutting elements 22, are wires 23, and 30, but may, in other embodiments be a cutting blade 32, as seen in FIG. 2. The cutting elements 22, whether wire or blade may be composed of metal, plastic, or other durable resilient material capable of cutting and slicing tofu.

As seen in FIG. 1, tofu cutting device 10, may in some embodiments, include measuring marks 34, and color indicators marks 36, for cutting guides for cutting tofu at various sizes and thickness. In FIG. 1, measuring marks 34, and color indicator marks 36, are placed on first support arm 18, and second support arm 20, of frame 14.

With reference now to FIG. 2, it is seen that tofu cutting device 10, may also be configured with first support arm 18, and second support arm 20, with a single cutting element 22, here blade 32. First support arm 18, and second support arm 20, may in this embodiment, be provided with sharp edges 38, providing additional tofu cutting surfaces. In this embodiment support arms 18, and 20, with sharp edges 38, and cutting element 22, which may be either a wire or wires 30, or cutting blade 32, provide for three cutting surfaces which may be used in a wide variety of positions and orientations. For example, a horizontal, vertical, or angled cut can be made with cutting element 22, or with sharp cutting edges 38, of first support arm 18, or second support arm 22. Of course, in other embodiments, such as that shown in FIG. 1, first support arm 18, and second support arm 20, may be provided without sharp cutting edges. Accordingly, multiple cuts of tofu may be made at different depths and sizes. Tofu cutting device 10, is particularly useful for cutting packaged tofu, where the tofu may be easily cut in multiple sizes and depths without removing the tofu from the container.

In both FIGS. 1 and 2, handle 12, is shown configured with curves for a comfortable and secure hand grip, however, other shapes and size handles may be easily substituted and used without departing from the scope of the invention. Handle 12, may be composed of metal, plastic, wood, composite or a combination of such, and shaped or configured in any way to provide a firm and durable gripping surface.

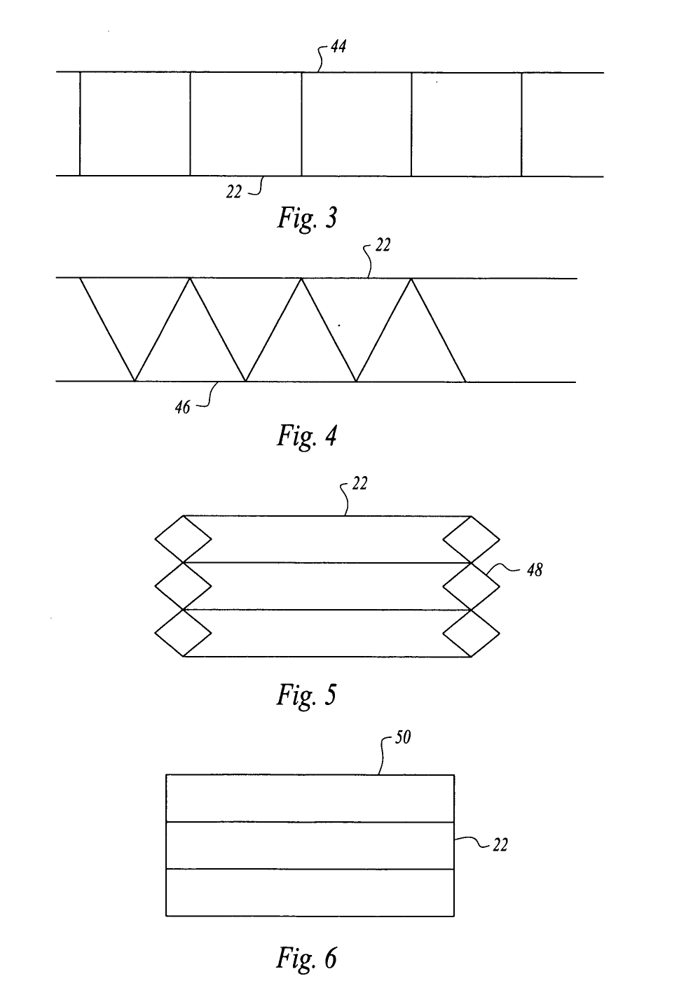

With reference now to FIGS. 3-6, examples of additional configurations of cutting elements 22, are shown. In FIG. 3, a square configuration 44, of a cutting element 22, for cutting tofu squares, is shown according to another embodiment of the invention.

In FIG. 4, triangular configuration 46, of cutting element 22, for cutting triangular tofu pieces, is shown according another embodiment of the invention.

Referring now to FIG. 5, spindly 48, or julienne type cutting element 22, configuration is shown according to another embodiment of the invention.

In FIG. 6, a layer type 50, cutting configuration of cutting element 22, is shown according to another embodiment of the invention. Of course, numerous and varied additional cutting element shapes and configurations may be provided in addition to the ones shown in FIGS. 1-6, which are examples of preferred embodiment. In other configurations, cutting elements 22, may be circular, or oval, tube shaped, or any other geometrical shape desired.

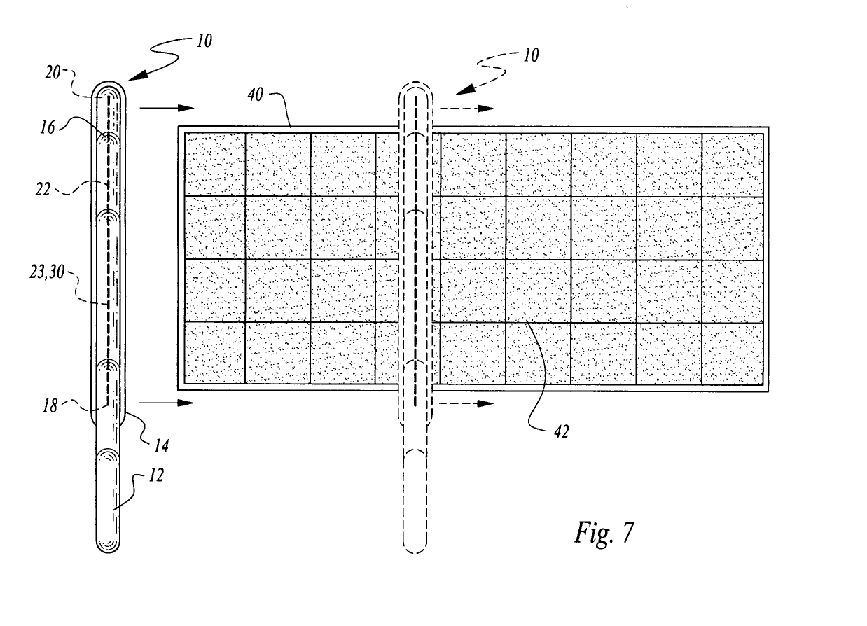

With reference now to FIG. 7, shows a tofu block 42, in a standard tofu container 40, which is typically a two inch tall, three by four inch container box, being cut by the tofu cutting device 10, with handle 12, frame element 14, first support arm 16, and second support arm 18, according to the invention. Here, squares of tofu are being cut by multiple cuts, but of course, any desired shape or size cut my be made as desired. It is seen that tofu cutting device can easily cut and prepare different sizes and depths of tofu without removing the tofu from the container. Tofu cutter 10, can cut multiple layers, in various and different sizes and configurations with cutting element(s) 22, here, wires 23 and 30, and is very easy to use in both large scale applications such as restaurants or in smaller scale operations such as in a user's kitchen.

In operation and use, tofu cutting device 10, is easy, efficient, and fun to use. Tofu cutting device 10, is particularly suited for culinary preparations and allows the tofu to be cut without removing it from packaging containers. In a preferred application, as seen in FIG. 7, a tofu block 42, is easily cut and prepared while still in the packaging container by tofu cutting device 10, aligning cutting element(s) 22, with the tofu and then the tofu cutting device 10, either pushed or pulled in a cutting or slicing manners through the tofu. Tofu cutting device 10, may be provided in a wide variety of different sizes and configurations, and made out of a wide variety of materials, such as plastic, metal, wood, or any other durable resilient material.

Additional advantages and modification will readily occur to those skilled in the art. The invention in its broader aspects is, therefore, not limited to the specific details, representative apparatus and illustrative examples shown and described. Accordingly, departures from such details may be made without departing from the spirit or scope of the applicant's general inventive concept.

What is claimed is:

1. A tofu cutting device, comprising:
a handle;
a frame element secured to said handle;
one or more cutting elements for cutting said tofu, said one or more cutting elements being operably positioned and secured on said frame element.

2. The tofu cutting device of claim 1, wherein said frame element has a base and a first support arm and a second support arm for holding and supporting said one or more cutting elements.

3. The tofu cutting device of claim 1, wherein said one or more cutting element are composed of wire.

4. The tofu cutting device of claim 1, wherein said one or more cutting elements are blades.

5. The tofu cutting device of claim 1, wherein said one or more cutting elements are composed of metal.

6. The tofu cutting device of claim 1, wherein said one or more cutting elements are composed of plastic.

7. The tofu cutting device of claim 2, wherein said two support arms have measuring marks and color indicators for cutting guides.

8. The tofu cutting device of claim 2, wherein said first support arm and said second support arm have sharp edges providing additional tofu cutting surfaces.

9. A tofu cutting device, for cutting packaged tofu comprising:
a handle;
a frame element secured to said handle;
one or a plurality of cutting elements for cutting said tofu; said one or said plurality of cutting elements being operably positioned and secured on said frame element.

10. The tofu cutting device of claim 9, wherein said frame element has a base and a pair of support arms for holding and positioning said one or said plurality of cutting elements.

11. The tofu cutting device of claim 9, wherein said one or said plurality of cutting elements are composed of wire.

12. The tofu cutting device of claim 9, wherein said one or said plurality of cutting elements are blades.

13. The tofu cutting device of claim 9, wherein said one or said plurality of cutting elements are composed of metal.

14. The tofu cutting device of claim 9, wherein said one or said plurality of cutting elements are composed of plastic.

15. The tofu cutting device of claim 10, wherein said pair of support arms have measuring marks and color indicators for cutting guides.

16. The tofu cutting device of claim 10, wherein said pair of support arms have sharp edges providing additional tofu cutting surfaces.
